(19) United States
(12) Patent Application Publication
(10) Pub. No.: US 2009/0037159 A1
(43) Pub. Date: Feb. 5, 2009

(54) Method and System for Developing Lubricants, Lubricant Additives, and Lubricant Base Stocks Utilizing Atomistic Modeling Tools

(76) Inventors: Hongmei Wen, South Winsor, CT (US); Clark V. Cooper, Arlington, VA (US)

Correspondence Address: PRATT & WHITNEY, 400 MAIN STREET, MAIL STOP: 132-13, EAST HARTFORD, CT, 06108, US

(21) Appl. No.: 11/887,685

(22) PCT Filed: Dec. 2, 2005
(86) PCT No.: PCT/US2005/043884

§ 371 Date: Oct. 2, 2007

Related U.S. Application Data
(60) Provisional application No. 60/634,161, filed on Dec. 6, 2004.

(51) Int. Cl. G06F 19/00

(52) U.S. Cl. 703/6

(57) ABSTRACT

A method and system for developing lubricant, as well as the lubricant, is provided. According to performance requirements for the lubricant, atomistic modeling tools are used to design a formulation for the lubricant that will substantially meet a set of performance requirements. The formulation comprises lubricant additive(s), lubricant base stock(s), or the combination of lubricant additive(s) and lubricant base stock(s).

### CROSS-REFERENCE TO RELATED APPLICATIONS

The present application claims the benefit of U.S. Provisional Application No. 60/634,161 filed Dec. 6, 2004, and is related to the following co-pending and commonly-owned application which was filed herewith, both of which are hereby incorporated by reference in full: “Systems and Methods for Modeling Surface Properties of a Mechanical Component” (Attorney Docket No. 0002338WOU, EH-11736).

### GOVERNMENT RIGHTS IN THE INVENTION

The invention was made by or under contract with the National Institute of Standards and Technology of the United States Government under contract number 70NANB0H3048.

### BACKGROUND OF THE INVENTION

1. Field of the Invention

The present invention relates to a method of developing lubricants, lubricant base stocks, and/or lubricant additives. More particularly, the present invention relates to a method of developing lubricants, lubricant base stocks, and/or lubricant additives utilizing atomistic modeling.

2. Description of Related Art

Mechanical systems such as manual or automatic transmissions; single and multi-speed aviation transmissions; push-belt type continuous variable transmissions; and traction drive continuous variable transmissions, have large surface areas of contact zones. These contact portions or zones, such as drive rolling surfaces, gears, ball-bearings and roller-bearings, are known to be susceptible to high surface pressures. Moreover, the need for reducing friction, resistance, and fatigue within larger contact zones of mechanical systems is increased by many recently developed transmission systems that are designed to be miniaturized or weight-reduced to maximize transmission throughput capacity. Additional applications of the lubricants, lubricant base stocks, and lubricant additives that may be designed or developed using the methods taught herein include, but are not limited to, (1) internal and external combustion engines and other propulsive devises, such as those used in the automotive industry, especially those that are subject to intense and demanding duty cycles, such as racing and other high performance applications; (2) machinery and apparatus used in the preparation of food; (3) drilling and conveying systems and apparatus, for example, as used in the mineral and oil and gas mining industries; etc.

To alleviate the high surface pressures of contact zones, lubricants, especially those containing specific additives, play a critical role in protecting and minimizing the wear and scuffing of surfaces. The lubricants generally reduce principal damage accumulation mechanisms of lubricated components caused by surface fatigue and overloading.

A lubricant is typically composed of a base stock and one or more additives. Lubricant additives play critical roles in improving the properties and performance of the base stock. Recently developed system-optimization approaches for increasing overall power throughput of mechanical systems underscore the need for new and better performing lubricants. By reducing friction and wear, pressure and scoring resistance, improved lubricants can prolong surface fatigue life for lubricated contacts within transmission systems and other systems.

The current approach to the design of lubricant base stock and additives is by trial and error. This is due mainly to the fact that the interactions among various additives, base stocks, and applied mechanical contacting surfaces are very complicated. Also, the mechanisms through which the various lubricant components function are frequently unknown or poorly understood.

There is a need for a systematic approach to the design of lubricants. The present invention provides a systematic way to design lubricants, lubricant base stocks, and/or lubricant additives using atomistic modeling tools. Atomistic modeling tools can elucidate the functional mechanism of the lubricant for a given application by studying the interactions of the ingredients and constituents of a lubricant and the contact surfaces. Subsequently, according to the requirements of an application, lubricants, lubricant base stocks, and/or lubricant additives can be designed/selected by simulating the operating conditions using atomistic modeling.

Atomistic modeling tools include those that provide atomistic properties of materials. The atomistic modeling simulates the atomistic structure of a studied system from atomistic length scale up to micrometer length scale. Atomistic modeling provides structural, electronic, magnetic, and energetic information about a studied system. It can be used to study the kinetic and dynamic properties of a system. Common examples of these tools include density functional theory, molecular dynamics, and Monte Carlo simulations.

The present invention provides a method of developing lubricants utilizing atomistic modeling tools. The use of atomistic modeling to develop lubricants, lubricant base stocks, and/or lubricant additives offers an attractive complement to experimental studies by screening lubricant candidates in an efficient, effective, and economical way. This leads to the reduction of direct R&D costs, and augments, expedites, and/or avoids traditional trial-and-error additive-development processes. Atomistic modeling can allow new products to be brought to market quicker than otherwise possible.

### BRIEF SUMMARY OF THE INVENTION

The present invention provides methods and systems of developing lubricants, lubricant base stocks, and/or lubricant additives using atomistic modeling tools.

A method for developing lubricants, lubricant base stocks, and/or lubricant additives is provided. The method includes, but is not limited to, establishing a set of performance requirements for the lubricants, lubricant base stocks, and/or lubricant additives and utilizing atomistic modeling tools to predict a formulation for the lubricants, lubricant base stocks, and/or lubricant additives that will substantially meet the set of performance requirements. The formulation includes a lubricant base stock, at least one lubricant additive, and/or a lubricant, which is a mixture of at least one lubricant additive and a lubricant base stock.

A method for developing lubricants, lubricant base stocks, and/or lubricant additives is provided that includes, but is not limited to, building a database of additives, building a database of materials, building a database of contacting surfaces, building a database of lubricant base stocks, and building a database of functional mechanisms. A set of performance requirements for the lubricant/lubricant base stock/lubricant additive(s) is established, and a formulation for the lubricant, lubricant base stock, and/or lubricant additives, based at least on the set of performance requirements, is selected based on understanding the mechanism of performance requirements. Atomistic modeling tools are utilized to predict the characteristics of the formulation and to determine whether an additional formulation should be prepared based on a determination of whether the set of characteristics is substantially equivalent to the set of performance requirements. The lubricant, lubricant base stock, and/or lubricant additives are formulated, and the formulation is tested experimentally to verify the performance characteristics. The steps of selection, utilization, determination, and experimental verification are repeated iteratively until the set of characteristics is substantially equivalent to the set of performance requirements. Then the formulation is finalized.

A system for developing lubricants, lubricant base stocks, and/or lubricant additives is also provided. The system comprises a database of lubricant base stocks, a database of lubricant additives, a database of materials each having a contacting surface, a database of functional mechanisms, the performance requirements, the atomistic modeling simulator for predicting and determining the performance characteristics, and experimental apparatus to verify actual performance.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWINGS

FIG. 1 illustrates an exemplary embodiment of a method according to the present disclosure of developing lubricants, lubricant base stocks, and/or lubricant additives using atomistic modeling tools.

FIG. 2 illustrates a case study in which the load carrying capacity of POE oil is improved via atomistic modeling as a design tool.

### DETAILED DESCRIPTION OF THE INVENTION

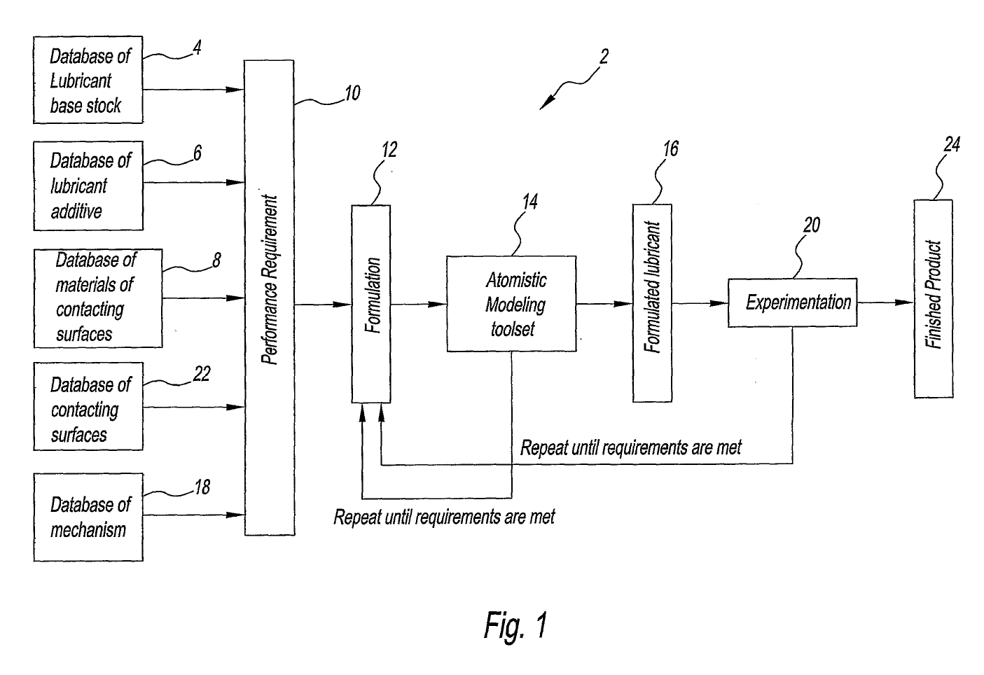

Referring to the drawings and in particular to FIG. 1, an exemplary embodiment of a method, process, or system for developing lubricants, lubricant base stocks, and/or lubricant additives is generally illustrated as reference numeral 2.

Method 2 includes building databases of lubricant additives 6, lubricant base stocks 4, materials of contacting surfaces 8, and contacting surfaces 22, To build these databases, a two-step procedure can be used. The first step is to obtain the initial atomistic structures of the lubricant additives 6, base stocks 4, materials of contacting surfaces 8, and contacting surfaces 22 from literature data or from experimental analyses, such as from nuclear magnetic resonance spectroscopy (NMR), mass spectrometry (MS), optical rotatory dispersion-circular dichroism (ORD-CD), and/or x-ray crystallography, or via atomistic modeling. The second step is to find the optimal atomistic structure by using Density Functional Theory or other atomistic modeling method. These obtained atomistic structures serve as inputs into the atomistic modeling tool 14 to study the performance of a selected formulation based on the required performance.

The Density Function Theory (DFT) is based on solving the many-particle Schroedinger equation for a model system of atoms. DFT provides structural, electronic, magnetic, and energetic information about a studied system. With current computing abilities, DFT calculations typically can accommodate a system of hundreds of atoms. The accuracy of DFT is comparable to current experimental technique. For example, the reaction activation energy is predicted to within 0.01 eV of experimental measurement, and the bond length is predicted to be within 0.02 Angstroms of experiment measurement.

In Method 2, a database of functional mechanisms of various performance requirements is built and expanded as more situations are studied.

The next step of Method 2 is to simulate performance characteristics of a formulation selected based on the performance requirement. Subsequently, the structures are allowed to relax and reach the energy-minimized optimal atomistic structures. Then, these optimal structures become the inputs for the larger system simulation, such as Molecular Dynamics (MD) or Monte Carlo (MC) simulation. In this case, MD and MC simulation are each examples of an atomistic modeling tool 14 utilized.

The MD simulation method, an atomistic modeling tool 14, is based on solving the classical equation of Newton's law of motion. It generates a trajectory of atomic positions and velocities varied with time and temperature. It also provides successive configurations generated by integrating Newton's law of motion. For current computation capability, MD simulation can accommodate a system up to millions of atoms. With the development of computation capability, MD can simulate larger systems.

The MC methods are stochastic techniques and each is an example of an atomistic modeling tool 14. These techniques are based on the use of random numbers and probability statistics to investigate problems. For current computation capability, MC simulation can accommodate a system up to millions of atoms. With the development of computation capability, MC can simulate larger systems. The particular MC methods that are utilized can be varied by one skilled in the art.

The kinetic Monte Carlo (KMC) simulation method, another example of an atomistic modeling tool 14, involves numerical simulation of the stochastic “master equation” to predict the temporal evolution of the system as it moves from state to state. The stochastic method provides statistically equivalent kinetics of a system without solving the deterministic kinetic equations or tracking the molecular dynamics for each atom.

The conventional MC method is used to study equilibrium properties of a system. KMC is a refinement to the conventional MC method which is necessary for following the real time evolution of a system.

Next, the database of functional mechanisms 18 required for lubricant additives 6 and/or lubricant base stock 4 to function is constructed. This is a critical step in the design of lubricants and lubricant additives. Once the functional mechanisms 18 of the lubricant additives 6 and/or lubricant base stock 4 are determined, one may proceed to design additive compositions to satisfy various requirements.

The steps to identify and understand the functional mechanisms 18 include the following: 1) application of DFT to study the chemical and physical interactions among the lubricant additives, lubricant base stock, and the contacting surfaces; 2) application of DFT to the chemical reactions that occur for the additives to function; and 3) application of DFT to study the interactions of the products formed through the reactions between the lubricant additives and the contacting surfaces.

Next, a set of performance requirements 10 for the lubricants, lubricant base stocks, and lubricant additives is established, such as enhancing scuffing performance, increasing surface fatigue life, increasing thermal stability, and increasing anti-oxidation capability. Based on these performance requirements 10, the initial lubricants, lubricant base stocks, and lubricant additives formulation 12 is selected from the database of existing lubricant additives 6 and lubricant base stocks 4 and/or is designed based on an understanding of the additive functional mechanisms 18. Subsequently, the integrated physical and chemical interactions between the molecules of the selected lubricant formulation 12 and the contacting surfaces of the materials 8 are analyzed by DFT, MD, MC or any other atomistic modeling simulation. In this case, DFT, MD and MC are each examples of an atomistic modeling tool 14 utilized.

As a result of either DFT, MD, or MC simulation, the compatibility of the formulated lubricants for the relevant contacting materials is determined. The optimal concentrations of the various lubricant additives 6 and base stocks 4 is also determined. The performance of the lubricant, such as its anti-oxidation and anti-scuffing capabilities, may be simulated and predicted by MD, MC, or any other existing or future atomistic modeling tool 14 and method.

If the initial lubricant formulation 12 does not meet the established set of performance requirements 10, another formulation 12 is selected to undergo similar analysis using an atomistic modeling tool 14. This step will be repeated iteratively until a lubricant formulation 12 meets the set of performance requirements 10.

After a formulation 12 is selected that meets the performance requirements 10, as shown using an atomistic modeling tool 14, the lubricant will be formulated. The performance of the formulated lubricant 16 will then be validated through experimentation 20. If, through experimentation 12, the performance of the formulated lubricant does not meet the performance requirements 10, an additional formulation 12 will be chosen and each of the steps will be repeated until such time as a formulated lubricant performs in accordance with the desired performance requirements 10 resulting in the finished product 24. The experimental techniques used to evaluate and determine the performance parameters of the resulting lubricant are known in the art.

The exemplary embodiment of method 2 for developing lubricants utilizes various atomistic modeling techniques, such as, for example, DFT, MC, MD, and KMC simulation. However, the present disclosure contemplates the use of other atomistic modeling techniques to develop lubricants.

The implementation of the atomistic modeling and/or other modeling and/or analysis can be done by a microprocessor or the like that is capable of performing such simulations. Preferably, the microprocessor is in communication with the databases of base stocks 4, additives 6 and materials database 8, and is capable of performing various algorithms, including, but not limited to, the algorithms associated with the DFT, MC, MD, and KMC modeling techniques. It is contemplated by the present invention that the microprocessor includes, but is not limited to, any circuit and/or programmable circuit which facilitates the function described above with respect to method 2, such as, but not limited to, computers, processors, microcontrollers, microcomputers, programmable logic controllers, application-specific integrated circuits, programmable circuits, and dedicated circuits including wireless communication capability.

The process described above for the method of producing a lubricant can be a software program or application that can be run on the microprocessor or other such device and can be a computer program product having a computer useable medium with a computer readable code means embodied in the medium for producing and/or formulating the lubricant. The software program or application can be readable by the microprocessor or other such device, tangibly embodying a program of instructions executable by the microprocessor to perform the above-described method or process for producing and/or formulating the lubricant. However, the present invention contemplates implementation of the method or process described herein in alternative ways, as well.

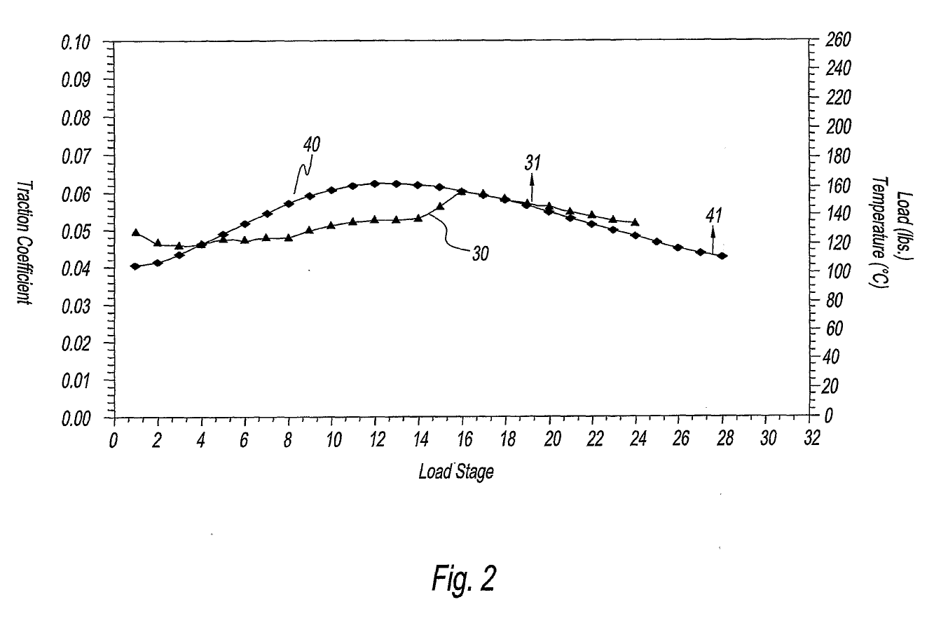

Referring now to FIG. 2, a case study showing the improvement in the load carrying capacity of polyol ester (POE) oil designed via atomistic modeling is illustrated. This atomistic modeling tool was used to study the anti-wearing functional mechanisms of a candidate lubricant additive. After understanding the functional mechanism, a lubricant additive package was designed and selected from a lubricant additive database. A lubricant was formulated by selecting additives from a database of lubricant additives and selecting a lubricant base stock from a database of lubricant base stocks. The scuffing performance of the designed lubricant was tested, and the load carrying capacity of the lubricant was found to increase by a factor of at least 1.43 times.

FIG. 2 shows the relationship between the average traction (friction) coefficient and average failure load stage for various lubricants. The vertical arrows 31, 41 indicate the average scuffing (scoring) failure load stage (load-carrying capacity) of the Exxon-Mobil Jet Oil II, and Formulation #2, respectively. “Load stage” in this context is a numerical value that is proportional to the force applied between the rotating ball and the rotating disc. A higher scuffing (scoring) failure load stage indicates greater load-carrying capacity of the lubricant. The results of Exxon-Mobil Jet Oil II are indicated by line 30; and the results of Formulation #2 are indicated by line 40. As can be seen FIG. 2, the Exxon-Mobil Jet Oil II had an average scuffing (scoring) failure load stage of about 19.2 (arrow 31), and Formulation #2 had an average scuffing (scoring) failure load stage of about 27.5 (arrow 41), which indicates that Formulation #2 has a load carrying capacity (i.e., scuffing or scoring performance) about 1.43 times greater than that of the Exxon-Mobil Jet Oil II. Further details of this case study can be found in co-pending and commonly-owned patent application Ser. No. ______ entitled “Lubricant Additive Packages for Improving Load-Carrying Capacity and Surface Fatigue Life” (Attorney Docket No. 0002290WOU, EH-11605), which is hereby incorporated in full by reference.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the invention without departing from the scope thereof. Therefore, it is intended that the present invention not be limited to the particular embodiment(s) disclosed as the best mode contemplated, but that the invention will include all embodiments falling within the scope of the appended claims.

What is claimed is:

1. A method for developing a lubricant, the method comprising:
establishing performance requirements for the lubricant; and
utilizing atomistic modeling tools to predict a formulation for the lubricant that will substantially satisfy said performance requirements, wherein said formulation comprises at least one lubricant additive, at least one lubricant base stock, or the combination of at least one lubricant additive and at least one lubricant base stock.

2. The method in accordance with claim 1, further comprising producing said formulation.

3. The method in accordance with claim 2, further comprising testing said formulation to determine performance parameters and comparing said performance parameters with said performance requirements.

4. A method for developing a lubricant, the method comprising the steps of:
building a database of additives;
building a database of materials, wherein each of said materials has a contacting surface;
building a database of base stocks;
building a database of contacting surfaces;
building a database of functional mechanisms;
establishing performance requirements for the lubricant;
selecting a formulation for the lubricant based, at least in part, on said performance requirements, wherein said formulation comprises at least one of said additives or at least one of said base stocks;
utilizing atomistic modeling tools to predict performance characteristics of said formulation;
determining whether an additional formulation should be prepared based, at least in part, on a comparison of whether said performance characteristics substantially satisfy said performance requirements;
repeating said selecting, utilizing, and determining steps until such time as said performance characteristics substantially satisfy said performance requirements; and
producing the lubricant according to said formulation,

5. The method in accordance with claim 4, further comprising testing the lubricant to determine performance parameters and comparing said performance parameters to said performance requirements.

6. A method for developing a lubricant, the method comprising:
establishing performance requirements for the lubricant;
selecting a formulation for the lubricant based, at least in part, on said performance requirements, wherein said formulation comprises at least one additive and at least one base stock;
utilizing atomistic modeling techniques to predict performance characteristics of said formulation;
determining whether said performance characteristics satisfy said performance requirements; and
formulating the lubricant according to said formulation if said performance characteristics satisfy said performance requirements, wherein said atomistic modeling is selected from the group consisting of density functional theory, molecular dynamics, Monte Carlo, or any combination thereof.

7. The method in accordance with claim 6, further comprising:
building a database of additives, wherein said at least one additive is chosen from said database of additives.

8. The method in accordance with claim 6, further comprising:
building a database of base stocks, wherein said at least one base stock is chosen from said database of base stocks.

9. The method in accordance with claim 8, wherein building said database of base stocks is based at least in part on atomistic modeling.

10. The method in accordance with claim 7, wherein building said database of additives is based at least in part on atomistic modeling.

11. The method in accordance with claim 6, further comprising utilizing atomistic modeling to select said at least one base stock for said formulation.

12. The method in accordance with claim 6, further comprising utilizing atomistic modeling to select said at least one additive for said formulation.

13. A lubricant development system for producing a lubricant, the system comprising:
a database of lubricant base stocks;
a database of lubricant additives; and
a microprocessor in communication with said database of lubricant base
stocks and said database of lubricant additives, wherein said microprocessor is used to determine a formulation comprising a lubricant base stock from said database of lubricant base stocks and a lubricant additive from said database of lubricant additives based at least in part on atomistic modeling.

14. The system of claim 13, wherein said microprocessor is used to determine whether performance characteristics of said formulation satisfy performance requirements of the lubricant.

15. The system of claim 14, wherein said atomistic modeling comprises algorithms, and wherein said microprocessor is used to perform iterations of said algorithms until said performance characteristics of said formulation satisfy said performance requirements of the lubricant.

16. The system of claim 14, wherein said microprocessor is used to build said database of lubricant base stocks based at least in part on atomistic modeling.

17. The system of claim 14, wherein said microprocessor is used to build said database of lubricant additives based at least in part on atomistic modeling.

18. The system of claim 14, wherein said atomistic modeling is selected from the group consisting of density functional theory, molecular dynamics, Monte Carlo, or any combination thereof.

19. A computer readable program embodied in an article of manufacture comprising computer readable program instructions for developing a formulation of a lubricant having an additive and a base stock, said program comprising:
program instructions for causing said computer to perform atomistic modeling on the formulation to predict performance parameters of the lubricant.

20. The program of claim 19, further comprising:
program instructions for causing a computer to read performance requirements for the lubricant; and
program instructions for causing said computer to determine whether said performance parameters satisfy said performance requirements.

21. The program of claim 19, further comprising:
program instructions for causing said computer to build a database of additives based upon atomistic modeling.

22. The program of claim 19, further comprising:
program instructions for causing said computer to build a database of base stocks based upon atomistic modeling.

23. The program of claim 19, wherein said atomistic modeling is selected from the group consisting of density functional theory, molecular dynamics, Monte Carlo, or any combination thereof.

24. A lubricant comprising:
an additive and a base stock, wherein a formulation for the lubricant is developed from a process comprising atomistic modeling to predict performance parameters of the lubricant.

25. The lubricant of claim 24, wherein said atomistic modeling is selected from the group consisting of density functional theory, molecular dynamics, Monte Carlo, or any combination thereof.

26. The lubricant of claim 24, wherein said additive is selected from a database of additives that is built based at least in part on atomistic modeling.

27. The lubricant of claim 24, wherein said base stock is selected from a database of base stocks that is built based at least in part on atomistic modeling.

28. A method or system for developing a lubricant utilizing atomistic modeling as herein before described with reference to FIG. 1.
